(19) United States
(12) Patent Application Publication
(10) Pub. No.: US 2008/0022509 A1
(43) Pub. Date: Jan. 31, 2008

(54) Method for manufacturing thin-film magnetic head

(75) Inventors: Makoto Sakai, Kawasaki (JP); Kotaro Yamazaki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/591,757

(22) Filed: Nov. 1, 2006

(30) Foreign Application Priority Data
Jul. 26, 2006 (JP) 2006-202809

(51) Int. Cl. G11B 5/127; H04R 31/00; C23F 1/00

(52) U.S. Cl. 29/603.12; 216/41; 216/47

(57) ABSTRACT

A method is provided to manufacture a thin-film magnetic head that includes an insulating layer having a swelling extending from the front end to the back end of the insulating layer and also includes a upper magnetic pole having an apex part, a narrow part located on the side close to the front end of the apex part, and a taper part broadened toward the back end of the upper magnetic pole. The method includes a step of forming the insulating layer; a step of forming a photosensitive resist layer on the insulating layer; a step of forming a first mask layer, having a first blanked region formed in the shape of the narrow part, on the photosensitive resist layer; and a step of forming a second mask layer, having a second blanked region formed in the shape of the taper part, on the photosensitive resist layer.

### BACKGROUND OF THE INVENTION

1. Field of the Invention

The present invention relates to a method for manufacturing a thin-film magnetic head including a recording head section including a lower magnetic pole, coils, and an upper magnetic pole.

2. Description of the Related Art

Japanese Unexamined Patent Application Publication No. 2004-95020 (hereinafter referred to Patent Document 1) discloses an exemplary thin-film magnetic head. FIG. 12 is an illustration of the thin-film magnetic head viewed from the side on which an air-bearing surface thereof is located. The thin-film magnetic head includes a recording head section 10 for recording data on a magnetic disk and a reproducing head section 12 for reproducing data.

In the thin-film magnetic head, the following layers are arranged on a ceramic substrate 13 in this order: an insulating layer 14 made of alumina or the like, a lower shield layer 15 made of nickel-iron or the like, another insulating layer 16 made of alumina or the like, an SAL layer 17 made of nickel-iron or the like, and a spacer layer 18 made of tantalum, titanium, or the like.

A pair of lead terminals 19 and 20 are arranged on the spacer layer 18. An MR layer 21 made of nickel-iron is disposed on the spacer layer 18 such that the MR layer 21 is located between the lead terminals 19 and 20. Another insulating layer 22 made of alumina or the like lies over the lead terminals 19 and 20 and the MR layer 21. An upper shield layer 23 made of nickel-iron or the like is disposed on the upper shield layer 22.

The following layers and terminals form the reproducing head section 12: the insulating layer 14, the lower shield layer 15, the insulating layer 16, the SAL layer 17, the spacer layer 18, the MR layer 21, the lead terminals 19 and 20, the upper shield layer 22, and the upper shield layer 23.

Another insulating layer 24 made of alumina or the like is disposed on the upper shield layer 23.

Coils 25 formed by plating are arranged in the insulating layer 24. An upper magnetic pole 26 is disposed on the insulating layer 24. A protective layer 27 made of alumina or the like is disposed on the upper magnetic pole 26.

The following components form the recording head section 10: the upper shield layer 23, the insulating layer 24, the coils 25, the upper magnetic pole 26, and the protective layer 27.

The upper shield layer 23 serves as a lower magnetic pole for the recording head section 10.

FIG. 13 is a sectional view of the recording head section 10. The recording head section 10 will now be described in detail with reference to FIG. 13. In FIG. 13, the left end face of the recording head section 10 serves as an air-bearing surface.

A lower magnetic pole end part 23a made of nickel-iron is disposed on the upper shield layer 23. The lower magnetic pole end part 23a has a thickness of about 6 to 7 μm. Since the thickness of the lower magnetic pole end part 23a is considerably large, the lower magnetic pole end part 23a cannot be formed by sputtering but by electroplating.

The lower magnetic pole end part 23a has a hollow 23b extending to the upper shield layer 23. A first insulating layer 28 formed by sputtering using alumina or the like is disposed on a region of the upper shield layer 23 that is exposed from the hollow 23b. The coils 25 formed by plating are arranged on the first insulating layer 28.

A second insulating layer 29 formed by packing a resist into the hollow 23b lies over the coils 25.

The second insulating layer 29 is planarized by lapping such that the second insulating layer 29 is flush with the lower magnetic pole end part 23a.

A high-magnetic permeability layer 30 is disposed on a surface of the lower magnetic pole end part 23a that is located on the side close to a front end for writing and opposed to the upper magnetic pole 26 with a gap layer 31 disposed between the surface thereof and the upper magnetic pole 26. The high-magnetic permeability layer 30 is made of a material, such as cobalt-nickel-iron (Co—Ni—Fe), having a magnetic permeability greater than that of the lower magnetic pole end part 23a and has a thickness of about 0.5 μm. The high-magnetic permeability layer 30 can hardly be formed by electroplating but by sputtering.

### The gap layer 31 which is made of silicon dioxide (SiO₂) which is insulative lies over the high-magnetic permeability layer 30 and the second insulating layer 29.

A third insulating layer 32 made of a resist is disposed on a region of the gap layer 31 such that the third insulating layer 32 lies over the second insulating layer 29 and a portion of the high-magnetic permeability layer 30 adjacent thereto.

The third insulating layer 32 has a coronoid part 33 that can be formed by adjusting the viscosity of the resist so as to have an end portion tapered toward the high-magnetic permeability layer 30 (a portion of the lower magnetic pole end part 23a). The coronoid part 33 forms a swelling extending from the lower magnetic pole end part 23a to the back end of the third insulating layer 32.

The upper magnetic pole 26 extends over the gap layer 31 and the third insulating layer 32. The upper magnetic pole 26 can be formed in such a manner that a photosensitive resist layer (not shown) is formed over the gap layer 31 and the third insulating layer 32 and then partly removed by a photolithographic process so as to have a space with the same shape as that of the upper magnetic pole 26 and the upper magnetic pole 26 is provided in the space by electroplating.

In particular, a mask layer having a blanked region formed in the shape of the upper magnetic pole 26 is provided on the photosensitive resist layer. A portion of the photosensitive resist layer that is exposed from the blanked region of the mask layer and that corresponds to the upper magnetic pole 26 is removed by exposure. The upper magnetic pole 26 is provided in the removed portion by electroplating.

The upper magnetic pole 26 has a magnetic pole end part 26e located at the front end thereof and also has an apex part 26a with a shape similar to that of the coronoid part 33. The apex part 26a projects upward and extends from the magnetic pole end part 26e to the back end of the upper magnetic pole 26.

The protective layer 27, which is formed after the photosensitive resist layer is removed, lies over the upper magnetic pole 26 as shown in FIG. 12. These components form the recording head section 10.

FIG. 14 is a top view of the upper magnetic pole 26 shown in FIG. 13. With reference to FIG. 14, the upper magnetic pole 26 has a narrow part 26b extending from the apex part 26a to the magnetic pole end part 26e located at the front end of the upper magnetic pole 26 and also has a taper part 26c which is located on the side close to the back end of the apex part 26a and which is broadened from the narrow part 26b toward the back end of the upper magnetic pole 26. That is, the apex part 26a, which is a step projecting in the direction (the vertical direction in FIG. 13) in which the above layers for forming the recording head section 10 are stacked, is located between the narrow part 26b and the taper part 26c. The apex part 26a usually has a height of about 1 μm.

Since the apex part 26a projects as described above, the narrow part 26b and the taper part 26c cannot be simultaneously brought into focus when the photosensitive resist layer is treated by the photolithographic process. Therefore, regions of the photosensitive resist layer are separately subjected to exposure using different masks for forming the respective narrow and taper parts 26b and 26c between which the apex part 26a is sandwiched.

In particular, as shown in FIG. 15A, a first mask layer 34 which is hatched in this figure and which has a first blanked region 34a formed in the shape of the narrow part 26b is provided on the photosensitive resist layer such that the first blanked region 34a is located on a first exposure region 40a of the photosensitive resist layer. The first exposure region 40a thereof is subjected to exposure. The first mask layer 34 is then removed from the photosensitive resist layer.

As shown in FIG. 15B, a second mask layer 36 which is hatched in this figure and which has a second blanked region 36a formed in the shape of the taper part 26c is provided on the photosensitive resist layer such that the second blanked region 36a is located on a second exposure region 40b of the photosensitive resist layer. The second exposure region 40b thereof is subjected to exposure. The second mask layer 36 is then removed from the photosensitive resist layer.

The photosensitive resist layer is developed, whereby the first and second exposure regions 40a and 40b, subjected to exposure, corresponding to the upper magnetic pole 26 are removed.

With reference to FIG. 16, the first blanked region 34a of the first mask layer 34 and the second blanked region 36a of the second mask layer 36 have respective common portions 38 that overlap. The common portions 38 are necessary to eliminate an unexposed portion from a region for forming the upper magnetic pole 26.

Since a region of the photosensitive resist layer that is located directly under the common portions 38 is subjected to exposure twice, the light exposure of this region is greater than that of other regions of the photosensitive resist layer that are used to form the upper magnetic pole 26. This causes a portion of the photosensitive resist layer that corresponds to a boundary part 26d located between the narrow part 26b and the taper part 26c to have a width greater than a desired width indicated by broken lines shown in FIG. 17. That is, in the upper magnetic pole 26, the boundary part 26d has a width slightly greater than a desired width indicated by the broken lines in FIG. 17 when viewed in the direction perpendicular to a straight line joining the magnetic pole end part 26e and the back end of the upper magnetic pole 26.

The distance between the boundary part 26d and the magnetic pole end part 26e, that is, the length of the narrow part 26b affects recording properties of the recording head section 10. In the thin-film magnetic head, the boundary part 26d has a width greater than a desired width as described above and the narrow part 26b has a length less than a desired length. Therefore, there is a problem in that the thin-film magnetic head disclosed in Patent Document 1 cannot have desired recording properties. Furthermore, there is a problem in that there are serious differences in recording properties between thin-film magnetic heads manufactured by a conventional method.

### SUMMARY OF THE INVENTION

The present invention has been made to solve the above problems. It is an object of the present invention to provide a method for manufacturing a thin-film magnetic head which includes a recording head section having an upper magnetic pole formed properly and which has good recording properties, the method being useful in manufacturing products hardly having differences in recording properties.

A first aspect of the present invention provides a method for manufacturing a thin-film magnetic head that includes an insulating layer having a swelling extending from the front end to the back end of the insulating layer and also includes a upper magnetic pole having an apex part, a narrow part located on the side close to the front end of the apex part, and a taper part which is located on the side close to the back end of the apex part and which is broadened toward the back end of the upper magnetic pole, the upper magnetic pole being disposed on the insulating layer. The method includes a step of forming the insulating layer; a step of forming a photosensitive resist layer on the insulating layer; a step of forming a first mask layer, having a first blanked region formed in the shape of the narrow part, on the photosensitive resist layer; and a step of forming a second mask layer, having a second blanked region formed in the shape of the taper part, on the photosensitive resist layer. The step of forming the photosensitive resist layer is subsequent to the step of forming the insulating layer. The second blanked region has an end portion which is located on the side close to the front end of the upper magnetic pole and which is more close to the back end of the upper magnetic pole than a position corresponding to a boundary part between the narrow part and the taper part.

According to the method of the first aspect of the present invention, since the end portion of the second blanked region is more close to the back end of the upper magnetic pole than the position corresponding to the boundary part between the narrow part and the taper part, a region of the photosensitive resist layer that is adjacent to a doubly exposed region present in the photosensitive resist layer and that is subjected to exposure through the first blanked region has a width less than that of a portion of the upper magnetic pole. This overcomes a phenomenon in which the doubly exposed region is enlarged during development to have a width greater than that of a portion of the first or second blanked region; hence, the upper magnetic pole can be formed so as to have a desired shape.

A second aspect of the present invention provides a method for manufacturing a thin-film magnetic head that includes an insulating layer having a swelling extending from the front end to the back end of the insulating layer and also includes a upper magnetic pole having an apex part, a narrow part located on the side close to the front end of the apex part, and a taper part which is located on the side close to the back end of the apex part and which is broadened toward the back end of the upper magnetic pole, the upper magnetic pole being disposed on the insulating layer. The method includes a step of forming the insulating layer; a step of forming a photosensitive resist layer on the insulating layer; a step of forming a first mask layer, having a first blanked region formed in the shape of the narrow part, on the photosensitive resist layer; and a step of forming a second mask layer, having a second blanked region formed in the shape of the taper part, on the photosensitive resist layer. The step of forming the photosensitive resist layer is subsequent to the step of forming the insulating layer. The first blanked region has a narrow portion which is located close to a position corresponding to a boundary part between the narrow part and the taper part and which has a width less than that of the narrow part.

According to the method of the second aspect of the present invention, the first blanked region has a narrow portion placed close to a doubly exposed region present in the photosensitive resist layer and the narrow portion of the first blanked region has a width less than that of the narrow part of the upper magnetic pole. This overcomes a phenomenon in which the doubly exposed region is enlarged during development to have a width greater than that of a portion of the first or second blanked region; hence, the upper magnetic pole can be formed so as to have a desired shape.

The method of the first or second aspect of the present invention further includes a step of subjecting areas of the photosensitive resist layer to exposure, removing the first mask layer, and then providing the second mask layer on the photosensitive resist layer, the areas being exposed from the first mask layer.

In the method of the first or second aspect of the present invention, the narrow portion of the first blanked region is tapered gradually toward the back end of the upper magnetic pole.

In the method of the first or second aspect of the present invention, the narrow portion of the first blanked region is tapered stepwise toward the back end of the upper magnetic pole.

According to the method of the first or second aspect of the present invention, the upper magnetic pole can be properly formed; hence, the thin-film magnetic head has good recording properties and there are substantially no differences in recording properties between products manufactured by the method.

### BRIEF DESCRIPTION OF THE DRAWINGS

FIGS. 1A and 1B are illustrations showing steps included in a method for manufacturing a thin-film magnetic head according to an embodiment of the present invention;

FIG. 2A is an illustration of a first mask layer, having a first blanked region, used in a method according to a first embodiment of the present invention and FIG. 2B is an illustration of a second mask layer, having a second blanked region, used in this method;

FIG. 3 is an illustration of an imaginary situation in which the first and second mask layers used in the method of the first embodiment overlap;

FIG. 4A is an image of a photosensitive resist layer developed in a step included in the method of the first embodiment and FIG. 4B is an image of a photosensitive resist layer developed in a step included in a conventional method for manufacturing a thin-film magnetic head;

FIG. 5A is an image of an upper magnetic pole formed in a step included in the method of the first embodiment and FIG. 5B is an image of an upper magnetic pole formed in a step included in the conventional method;

FIG. 6A is an illustration of a first mask layer, having a first blanked region, used in a method for manufacturing a thin-film magnetic head according to a second embodiment of the present invention and FIG. 6B is an illustration of a second mask layer, having a second blanked region, used in this method;

FIG. 7 is an illustration of an imaginary situation in which the first and second mask layers used in the method of the second embodiment overlap;

FIG. 8A is an illustration of a first mask layer, having a first blanked region, used in a method for manufacturing a thin-film magnetic head according to a third embodiment of the present invention and FIG. 8B is an illustration of a second mask layer, having a second blanked region, used in this method;

FIG. 9 is an illustration of an imaginary situation in which the first and second mask layers used in the method of the third embodiment overlap;

FIG. 10A is an illustration of a first mask layer, having a first blanked region, used in a method for manufacturing a thin-film magnetic head according to a fourth embodiment of the present invention and FIG. 10B is an illustration of a second mask layer, having a second blanked region, used in this method;

FIG. 11 is an illustration of an imaginary situation in which the first and second mask layers used in the method of the fourth embodiment overlap;

FIG. 12 is an illustration showing the configuration of a thin-film magnetic head;

FIG. 13 is a sectional view of a recording head section;

FIG. 14 is an illustration showing the shape of an upper magnetic pole;

FIG. 15A is an illustration of a first mask layer, having a first blanked region, used in a conventional method for method for manufacturing a thin-film magnetic head and FIG. 15B is an illustration of a second mask layer, having a second blanked region, used in this method;

FIG. 16 is an illustration of an imaginary situation in which the first and second mask layers used in the conventional method overlap; and

FIG. 17 is an illustration showing the shape of an upper magnetic pole manufactured by the conventional method.

### DESCRIPTION OF THE PREFERRED EMBODIMENTS

Preferred embodiments of the present invention will now be described.

A thin-film magnetic head manufactured by a method according to each embodiment of the present invention has substantially the same configuration as that of the thin-film magnetic head shown in FIG. 12. The description of this thin-film magnetic head is omitted.

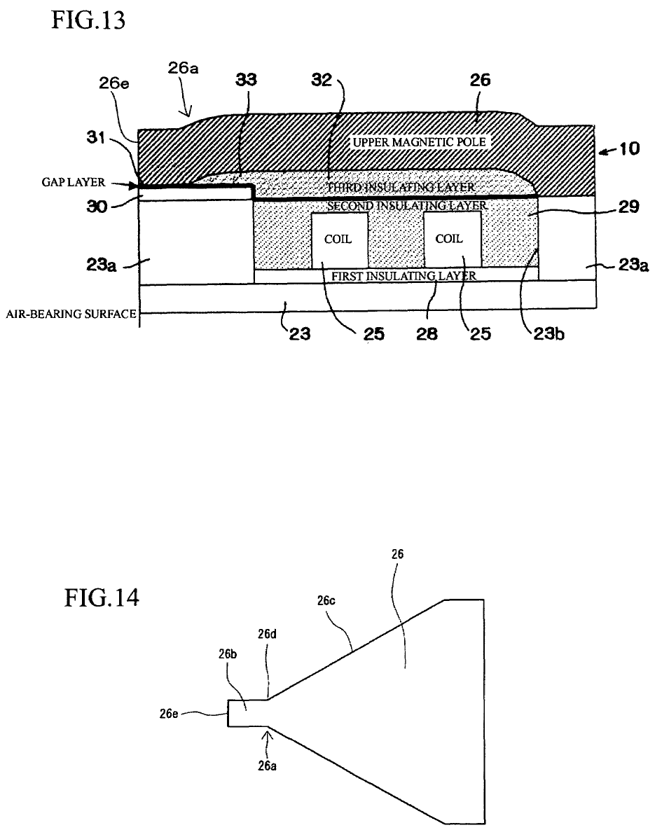

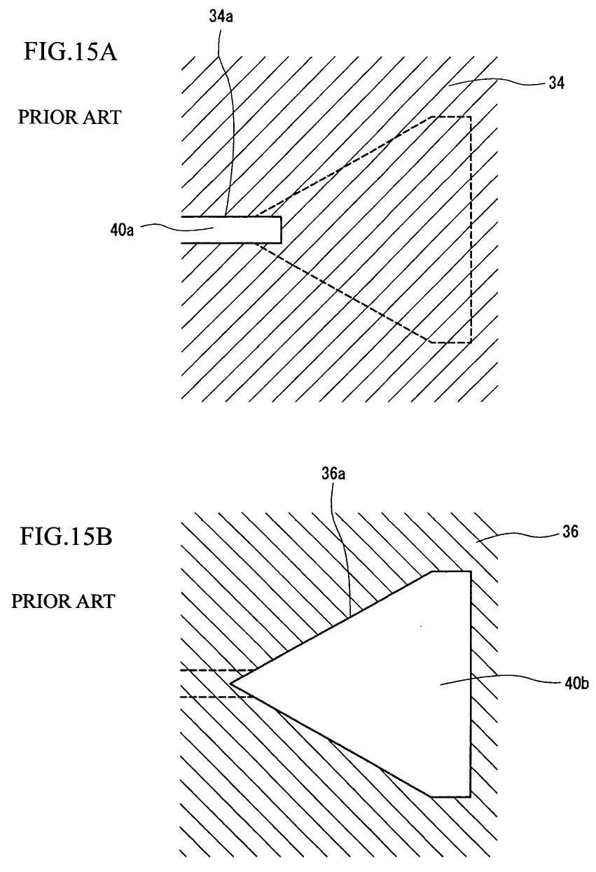

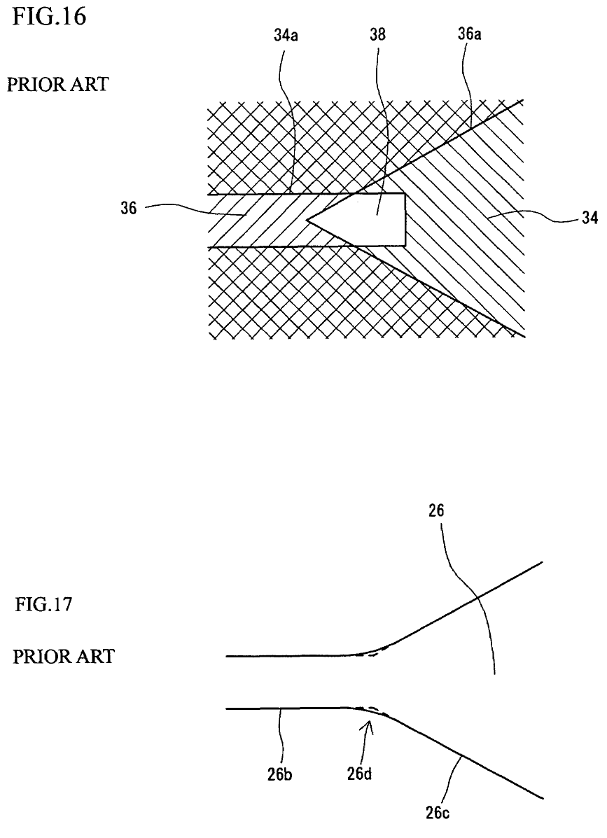

This thin-film magnetic head includes a recording head section 10 having substantially the same configuration as that of the recording head section 10 shown in FIG. 13. A procedure for forming this recording head section 10 is similar to that described in the description of the related art.

FIG. 13 is a sectional view of this recording head section 10. The forming procedure of this recording head section 10 will now be described in detail with reference to FIG. 13. In FIG. 13, the left end face of this recording head section 10 serves as an air-bearing surface.

A lower magnetic pole end part 23a made of nickel-iron is formed on a lower magnetic pole 23 serving as an upper shield layer by electroplating. The lower magnetic pole end part 23a has a thickness of about 6 to 7 μm. Since the thickness of the lower magnetic pole end part 23a is considerably large, the lower magnetic pole end part 23a cannot be formed by sputtering but by electroplating.

The lower magnetic pole end part 23a has a hollow 23b extending to the lower magnetic pole 23. A first insulating layer 28 made of alumina or the like is formed on a region of the lower magnetic pole 23 by sputtering, the region being exposed from the hollow 23b. Coils 25 are formed on the first insulating layer 28 by plating.

A second insulating layer 29 is formed in such a manner that a resist is packed into the hollow 23b so as to cover the coils 25.

The second insulating layer 29 is planarized by lapping such that the second insulating layer 29 is flush with the lower magnetic pole end part 23a.

A high-magnetic permeability layer 30 is formed on a surface of the lower magnetic pole end part 23a that is located on the side close to a front end for writing and that is to be opposed to a upper magnetic pole 26 with a gap layer 31 disposed between the surface thereof and the upper magnetic pole 26. The high-magnetic permeability layer 30 is made of a material, such as Co—Ni—Fe, having a magnetic permeability greater than that of the lower magnetic pole end part 23a and has a thickness of about 0.5 μm. Since it is difficult to form the high-magnetic permeability layer 30 by electroplating, the high-magnetic permeability layer 30 is formed by sputtering.

The gap layer 31 which is made of SiO2 which is insulative is formed over the high-magnetic permeability layer 30 and the second insulating layer 29.

A third insulating layer 32 made of a resist is formed on a region of the gap layer 31 such that the third insulating layer 32 lies over the insulating layer 29 and a portion of the high-magnetic permeability layer 30 that is adjacent to the second insulating layer 29.

The insulating layer 32 has a coronoid part 33 that can be formed by adjusting the viscosity of the resist so as to have an end portion tapered toward the high-magnetic permeability layer 30 (a portion of the lower magnetic pole end part 23a). The coronoid part 33 forms a swelling extending from the lower magnetic pole end part 23a to the back end of the lower magnetic pole 23.

A photosensitive resist layer 39 (not shown in this figure) is formed over the gap layer 31 and the insulating layer 32 and then partly removed by a photolithographic process so as to have a space formed in the shape of the upper magnetic pole 26. The upper magnetic pole 26 is provided in the space by electroplating.

In particular, each mask layer having a blanked region formed in the shape of the upper magnetic pole 26 is provided on the photosensitive resist layer 39. A portion of the photosensitive resist layer 39 that is exposed from the blanked region of the mask layer and that corresponds to the upper magnetic pole 26 is subjected to exposure and then removed. The upper magnetic pole 26 is provided in the removed portion by electroplating.

The upper magnetic pole 26 has a magnetic pole end part 26e located at the front end thereof and also has an apex part 26a with a shape similar to that of the coronoid part 33. The apex part 26a forms a swelling extending from the magnetic pole end part 26e to the back end of the upper magnetic pole 26.

After the photosensitive resist layer 39 is removed, a protective layer 27 is formed as shown in FIG. 12, whereby the recording head section 10 is formed.

FIG. 14 is a top view of the upper magnetic pole 26 shown in FIG. 13. With reference to FIG. 14, the upper magnetic pole 26 has a narrow part 26b extending from the apex part 26a to the magnetic pole end part 26e located at the front end of the upper magnetic pole 26 and also has a taper part 26c which is located on the side close to the back end of the apex part 26a and which is broadened from the narrow part 26b toward the back end of the upper magnetic pole 26. That is, the apex part 26a, which is a step projecting in the direction (the vertical direction in FIG. 13) in which the above layers for forming the recording head section 10 are stacked, is located between the narrow part 26b and the taper part 26c. The apex part 26a usually has a height of about 1 μm.

Since the apex part 26a projects as described above, the narrow part 26b and the taper part 26c cannot be simultaneously brought into focus when the photosensitive resist layer 39 is treated by the photolithographic process. Therefore, regions of the photosensitive resist layer 39 are separately subjected to exposure using different masks for forming the respective narrow and taper parts 26b and 26c between which the apex part 26a is sandwiched.

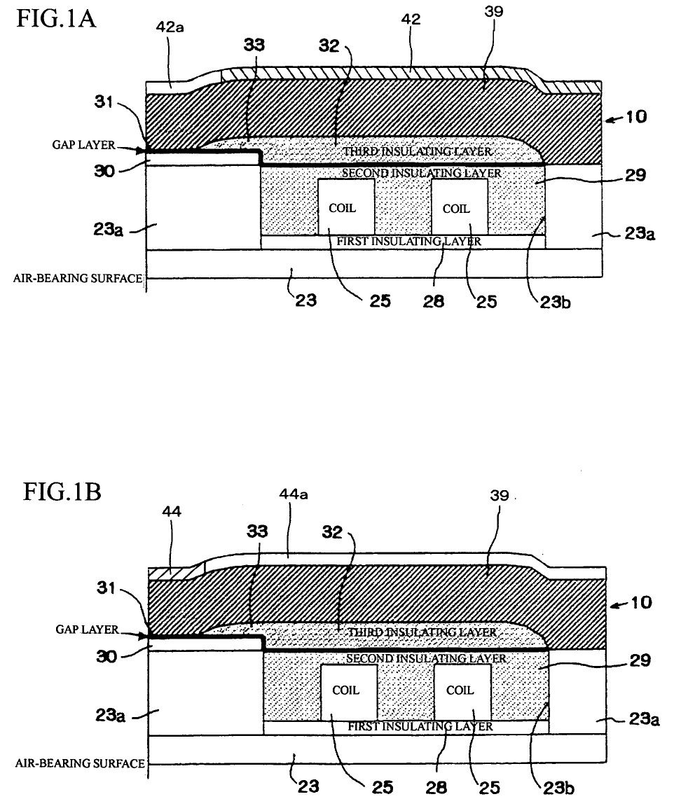

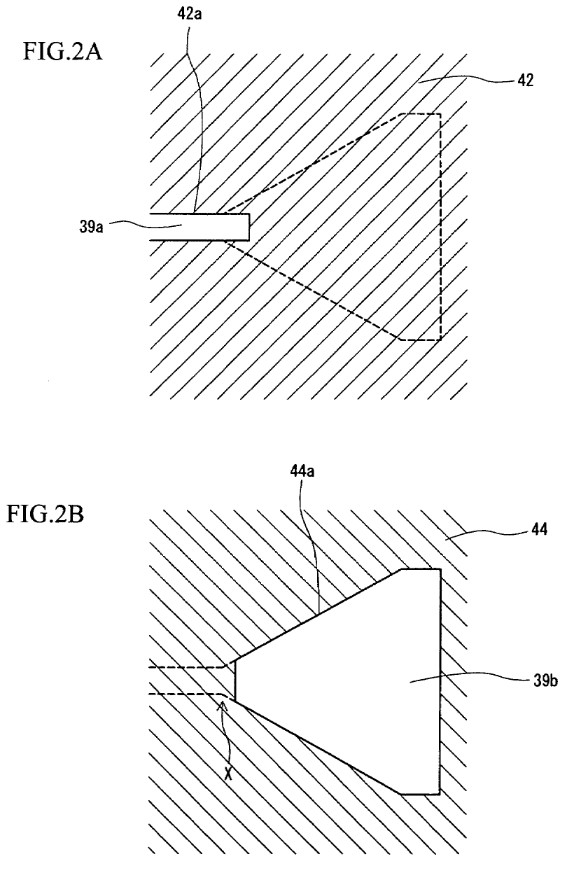

In particular, as shown in FIG. 1A, a first mask layer 42 having a first blanked region formed in the shape of the narrow part 26b is provided on the photosensitive resist layer 39 such that the first blanked region is located on a first exposure region 39a of the photosensitive resist layer 39. The first exposure region 39a thereof is subjected to exposure. The first mask layer 42 is then removed from the photosensitive resist layer 39.

As shown in FIG. 1B, a second mask layer 44 having a second blanked region formed in the shape of the taper part 26c is provided on the photosensitive resist layer 39 such that the second blanked region is located on a second exposure region 39b of the photosensitive resist layer. The second exposure region 39b thereof is subjected to exposure. The second mask layer 44 is then removed from the photosensitive resist layer 39.

The resulting photosensitive resist layer 39 is developed, whereby the first and second exposure regions 39a and 39b that correspond to the upper magnetic pole 26 are removed.

### First Embodiment

A method for manufacturing a thin-film magnetic head according to a first embodiment of the present invention is characterized in that a second mask layer 44 used in the method has a second blanked region 44a. The second blanked region 44a corresponds to a taper part 26c of an upper magnetic pole 26 included in the thin-film magnetic head and has a characteristic shape.

FIG. 2A shows a first mask layer 42 used in the method and FIG. 2B shows the second mask layer 44.

With reference to FIG. 2A, the first mask layer 42, which is hatched in this figure, has a first blanked region 42a having a portion formed in the shape of a narrow part 26b of the upper magnetic pole 26. The first blanked region 42a extends from a predetermined portion of the narrow part 26b to a predetermined portion of the taper part 26c and has the same width as that of the narrow part 26b.

The configuration of the first mask layer 42 is similar to that of a conventional first mask layer.

With reference to FIG. 2B, the second mask layer 44, which is hatched in this figure, has the second blanked region 44a formed in the shape of a portion of the taper part 26c. The second blanked region 44a has an end portion 44b which is located on the side close to a magnetic pole end part 26e of the upper magnetic pole 26 and which is more close to the back end of the upper magnetic pole 26 than a position, represented by X, corresponding to a boundary part 26d between the narrow part 26b and the taper part 26c.

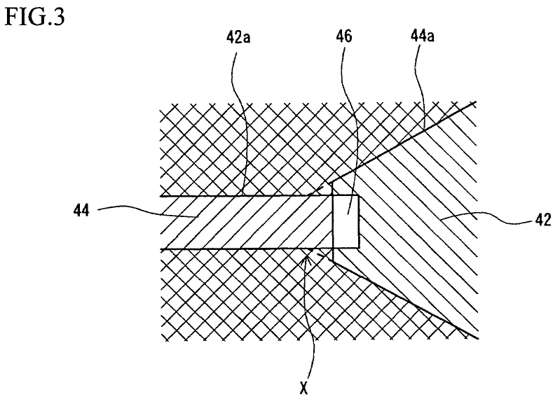

Since the first and second mask layers 42 and 44 are arranged on a photosensitive resist layer 39 as shown in FIG. 3, the photosensitive resist layer 39 has a doubly exposed region 46. With reference to FIG. 3, since the end portion 44b is more close to the back end of the upper magnetic pole 26 than the position X corresponding to the boundary part 26d, a region of the photosensitive resist layer 39 that is adjacent to the doubly exposed region 46 and that is exposed from the first blanked region 42a has a width less than that of a portion of the upper magnetic pole 26, the portion being sandwiched between two broken lines in FIG. 3. This overcomes a phenomenon in which the doubly exposed region 46 is enlarged during development to have a width greater than that of a portion of the first or second blanked region 42a or 44a; hence, the upper magnetic pole 26 can be formed so as to have a desired shape.

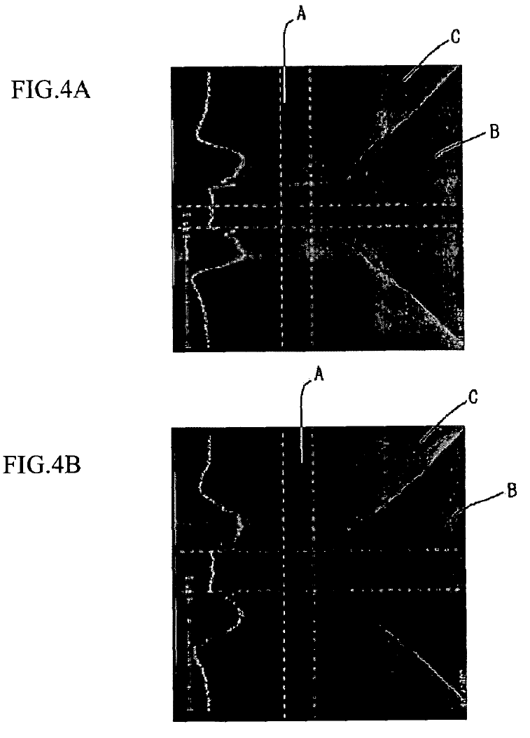

FIG. 4A is an image of the photosensitive resist layer 39 developed in a step included in the method of this embodiment and FIG. 4B is an image of a photosensitive resist layer developed in a step included in a conventional method for manufacturing a thin-film magnetic head. With reference to FIG. 4A, A represents a surface region of the photosensitive resist layer 39 developed in the step of the method of this embodiment, B represents a surface region of a third insulating layer 32 exposed by partly removing the photosensitive resist layer 39, and C represents a slope region of the photosensitive resist layer 39 that is sandwiched between the surface regions A and B. With reference to FIG. 4B, A represents a surface region of the photosensitive resist layer developed in the step of the conventional method, B represents a surface region of a third insulating layer 32 exposed by partly removing this photosensitive resist layer, and C represents a slope region of this photosensitive resist layer that is sandwiched between these surface regions A and B. As is clear from FIGS. 4A and 4B, the photosensitive resist layer 39 developed in the step of the method of this embodiment has a removed region located close to the position X corresponding to the boundary part 26d, the removed region has a width not greater than the desired width of a portion of the upper magnetic pole 26, sides of the narrow and taper parts 26b and 26c formed using the photosensitive resist layer 39 developed therein form a clearer angle as compared to the photosensitive resist layer developed in the step of the conventional method.

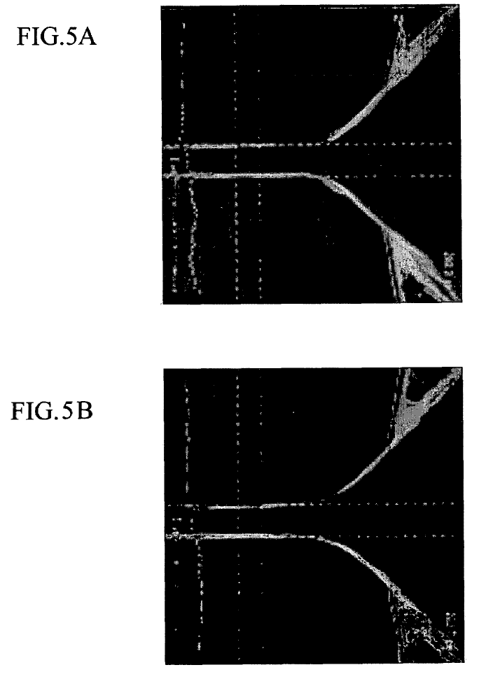

FIG. 5A is an image of the upper magnetic pole 26 formed in a step included in the method of this embodiment and FIG. 5B is an image of an upper magnetic pole formed in a step included in the conventional method.

As is clear from FIG. 5B, the upper magnetic pole formed in this step of the conventional method has a boundary part 26d (shown in FIG. 14) between a narrow part 26b and a taper part 26c and the boundary part 26d has a width slightly greater than a desired value when viewed in the direction perpendicular to a straight line joining a magnetic pole end part 26e and the back end of the upper magnetic pole. Furthermore, the boundary part 26d has curved edges. In contrast, as is clear from FIG. 5A, the boundary part 26d of the upper magnetic pole 26 formed in this step of the method of this embodiment has a width substantially equal to a desired value. Sides of the narrow and taper parts 26b and 26c of the upper magnetic pole 26 formed in this step of the method of this embodiment form a clearer angle as compared to the upper magnetic pole formed in this step of the conventional method.

### Second Embodiment

A method for manufacturing a thin-film magnetic head according to a second embodiment of the present invention is characterized in that a first mask layer 42 used in the method has a first blanked region 42a. The first blanked region 42a corresponds to a narrow part 26b of an upper magnetic pole 26 included in the thin-film magnetic head and which has a characteristic shape.

A recording head section 10 included in the thin-film magnetic head of this embodiment has substantially the same configuration as that of the recording head section 10 shown in FIG. 13. A procedure for forming the recording head section 10 of this embodiment is similar to that described in the first embodiment.

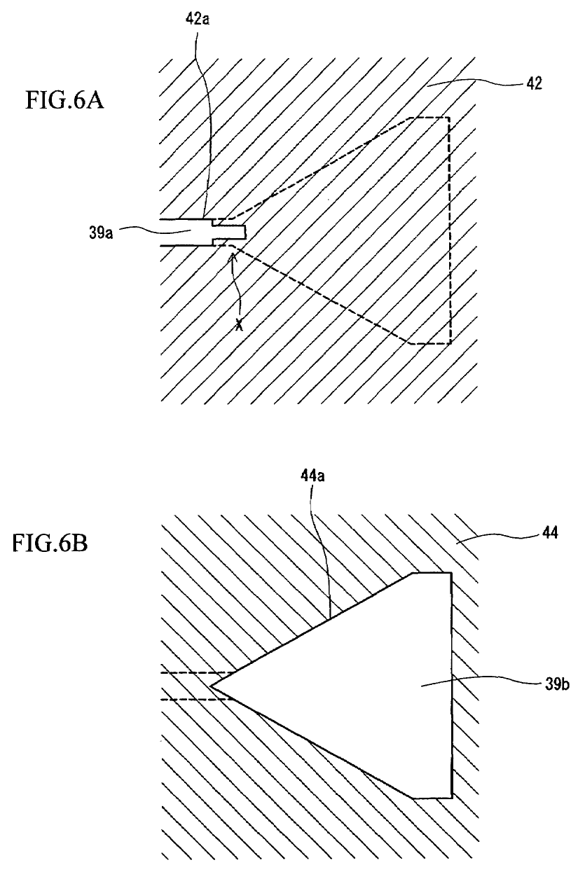

FIG. 6A shows the first mask layer 42 and FIG. 6B shows a second mask layer 44 used in the method of this embodiment.

With reference to FIG. 6A, the first blanked region 42a of the first mask layer 42 has a narrow portion located close to a position, represented by X, corresponding to a boundary part 26d between the narrow part 26b and a taper part 26c. The narrow portion of the first blanked region 42a has a width less than that of the narrow part 26b when viewed in the direction perpendicular to a straight line joining a magnetic pole end part 26e and the back end of the upper magnetic pole 26.

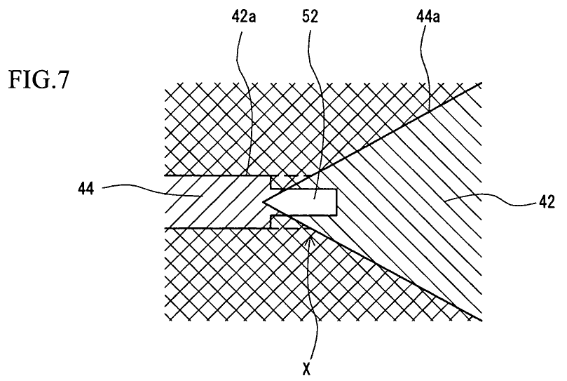

A photosensitive resist layer used in this embodiment has a doubly exposed region 52 as shown in FIG. 7. In this embodiment as well as the first embodiment, the narrow portion of the first blanked region 42a is effective in overcoming a phenomenon in which the doubly exposed region 52 is enlarged during development to have a width greater than that of a portion of the first or second blanked region 42a or 44a; hence, the upper magnetic pole 26 can be formed so as to have a desired shape.

### Third Embodiment

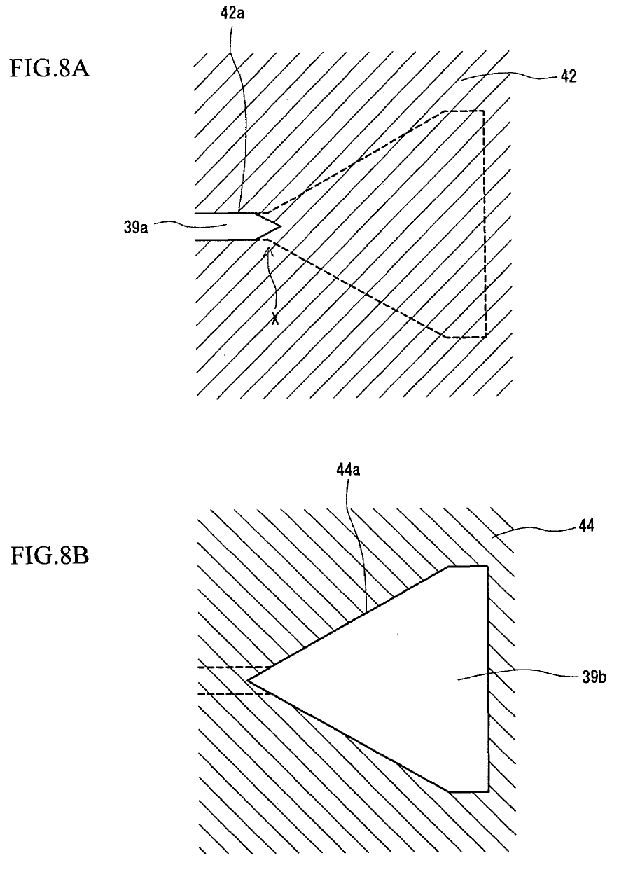

FIGS. 8A and 8B show a first mask layer 42 and second mask layer 44, respectively, used in a method for manufacturing a thin-film magnetic head according to a third embodiment of the present invention.

A recording head section 10 included in the thin-film magnetic head of this embodiment has substantially the same configuration as that of the recording head section 10 shown in FIG. 13. A procedure for forming the recording head section 10 of this embodiment is similar to that described in the first embodiment.

The method of this embodiment is characterized in that the first mask layer 42 used in this embodiment, as well as that used in the second embodiment, has a first blanked region 42a having a narrow portion located close to a position, represented by X, corresponding to a boundary part 26d between a narrow part 26b and a taper part 26c. The narrow portion of the first blanked region 42a has a width less than that of the narrow part 26b when viewed in the direction perpendicular to a straight line joining a magnetic pole end part 26e and the back end of an upper magnetic pole 26 included in the recording head section 10. The second mask layer 44 has a second blanked region 44a.

The difference between the method of this embodiment and the method of the second embodiment is that the narrow portion of the first blanked region 42a is tapered gradually toward the back end of the upper magnetic pole 26.

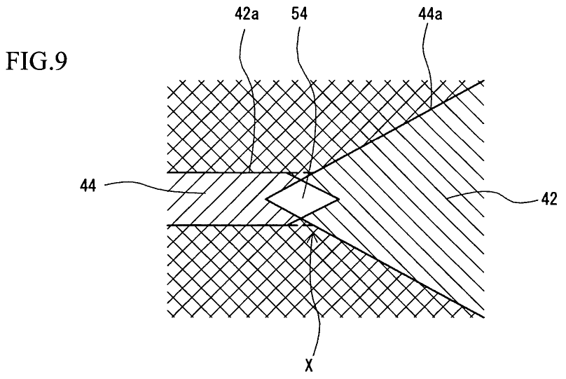

A photosensitive resist layer used in this embodiment has a doubly exposed region 54 as shown in FIG. 9. In this embodiment as well as the second embodiment, the narrow portion of the first blanked region 42a is effective in overcoming a phenomenon in which the doubly exposed region 54 is enlarged during development to have a width greater than that of a portion of the first or second blanked region 42a or 44a; hence, the upper magnetic pole 26 can be formed so as to have a desired shape.

### Fourth Embodiment

FIGS. 10A and 10B show a first mask layer 42 and second mask layer 44, respectively, used in a method for manufacturing a thin-film magnetic head according to a fourth embodiment of the present invention.

A recording head section 10 included in the thin-film magnetic head of this embodiment has substantially the same configuration as that of the recording head section 10 shown in FIG. 13. A procedure for forming the recording head section 10 of this embodiment is similar to that described in the first embodiment.

The method of this embodiment is characterized in that the first mask layer 42 used in this embodiment, as well as that used in the second or third embodiment, has a first blanked region 42a having a narrow portion located close to a position, represented by X, corresponding to a boundary part 26d between a narrow part 26b and a taper part 26c. The narrow portion of the first blanked region 42a has a width less than that of the narrow part 26b when viewed in the direction perpendicular to a straight line joining a magnetic pole end part 26e and the back end of an upper magnetic pole 26 included in the recording head section 10. The second mask layer 44 has a second blanked region 44a.

The difference between the method of this embodiment and the method of the second or third embodiment is that the narrow portion of the first blanked region 42a is tapered stepwise toward the back end of the upper magnetic pole 26.

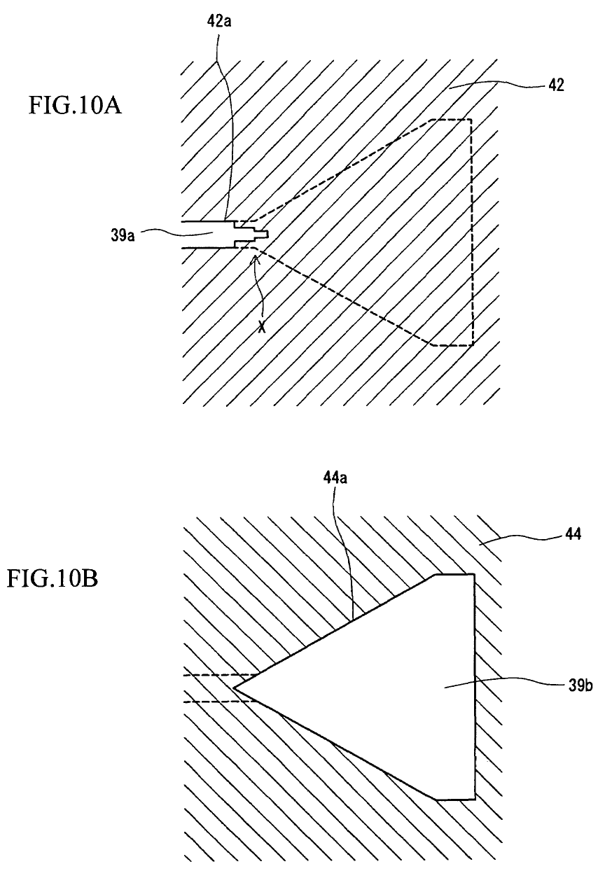

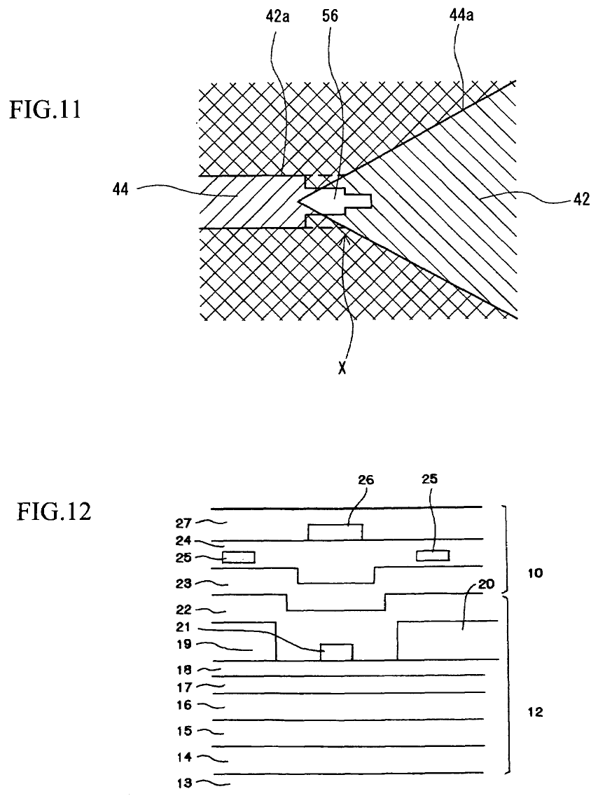

A photosensitive resist layer used in this embodiment has a doubly exposed region 56 as shown in FIG. 11. In this embodiment as well as the second embodiment, the narrow portion of the first blanked region 42a is effective in overcoming a phenomenon in which the doubly exposed region 56 is enlarged during development to have a width greater than that of a portion of the first or second blanked region 42a or 44a; hence, the upper magnetic pole 26 can be formed so as to have a desired shape.

What is claimed is:

1. A method for manufacturing a thin-film magnetic head that includes an insulating layer having a swelling extending from the front end to the back end of the insulating layer and also includes a upper magnetic pole having an apex part, a narrow part located on the side close to the front end of the apex part, and a taper part which is located on the side close to the back end of the apex part and which is broadened toward the back end of the upper magnetic pole, the upper magnetic pole being disposed on the insulating layer, the method comprising:
a step of forming the insulating layer;
a step of forming a photosensitive resist layer on the insulating layer;
a step of forming a first mask layer, having a first blanked region formed in the shape of the narrow part, on the photosensitive resist layer; and
a step of forming a second mask layer, having a second blanked region formed in the shape of the taper part, on the photosensitive resist layer,
wherein the step of forming the photosensitive resist layer is subsequent to the step of forming the insulating layer and the second blanked region has an end portion which is located on the side close to the front end of the upper magnetic pole and which is more close to the back end of the upper magnetic pole than a position corresponding to a boundary part between the narrow part and the taper part.

2. A method for manufacturing a thin-film magnetic head that includes an insulating layer having a swelling extending from the front end to the back end of the insulating layer and also includes a upper magnetic pole having an apex part, a narrow part located on the side close to the front end of the apex part, and a taper part which is located on the side close to the back end of the apex part and which is broadened toward the back end of the upper magnetic pole, the upper magnetic pole being disposed on the insulating layer, the method comprising:
a step of forming the insulating layer;
a step of forming a photosensitive resist layer on the insulating layer;
a step of forming a first mask layer, having a first blanked region formed in the shape of the narrow part, on the photosensitive resist layer; and
a step of forming a second mask layer, having a second blanked region formed in the shape of the taper part, on the photosensitive resist layer,
wherein the step of forming the photosensitive resist layer is subsequent to the step of forming the insulating layer and the first blanked region has a narrow portion which is located close to a position corresponding to a boundary part between the narrow part and the taper part and which has a width less than that of the narrow part.

3. The method according to claim 1, further comprising a step of subjecting areas of the photosensitive resist layer to exposure, removing the first mask layer, and then providing the second mask layer on the photosensitive resist layer, the areas being exposed from the first mask layer.

4. The method according to claim 2, further comprising a step of subjecting areas of the photosensitive resist layer to exposure, removing the first mask layer, and then providing the second mask layer on the photosensitive resist layer, the areas being exposed from the first mask layer.

5. The method according to claim 2, wherein the narrow portion of the first blanked region is tapered gradually toward the back end of the upper magnetic pole.

6. The method according to claim 2, wherein the narrow portion of the first blanked region is tapered stepwise toward the back end of the upper magnetic pole.
